(19) United States
(12) Patent Application Publication
(10) Pub. No.: US 2023/0166232 A1
(43) Pub. Date: Jun. 1, 2023

(54) LIGHTING DEVICE FOR PROVIDING LIGHT TO BE USED IN A PHOTOCHEMICAL REACTION

(71) Applicant: BASF SE, Ludwigshafen am Rhein (DE)

(72) Inventors: Bernd SCHAEFER, Ludwigshafen am Rhein (DE); Florian BUCHBENDER, Ludwigshafen am Rhein (DE); Steffen TSCHIRSCHWITZ, Ludwigshafen am Rhein (DE); Michael SCHREIBER, Ludwigshafen am Rhein (DE); Sorin PULBERE, Ludwigshafen am Rhein (DE)

(21) Appl. No.: 17/925,638

(22) PCT Filed: May 18, 2021
(86) PCT No.: PCT/EP2021/063207

§ 371 Date: Nov. 16, 2022

(30) Foreign Application Priority Data
May 18, 2020 (EP) 20175258.1

(51) Int. Cl. B01J 19/12; B01J 19/00

(52) U.S. Cl. CPC B01J 19/122; B01J 19/0013; B01J 2219/0871

(57) ABSTRACT

The invention relates to a lighting device, to the use of the lighting device in a photochemical reaction, to a photochemical reactor and to a method used by the lighting device. The lighting device 100 comprises an LED unit 110 configured to emit light 114 to be used in the photochemical reaction, a housing 120 configured to house the LED unit, wherein at least a part of the housing is transparent for light to be used in the photochemical reaction, wherein the housing is configured to contain a dielectric liquid transparent for light generated by the LED unit such that it is in direct contact with at least a part of the light emitting side of the LED unit, and a liquid movement arrangement 130 configured to support a movement of the dielectric liquid such that the dielectric liquid transports heat produced by the LED unit away from the LED unit.

### FIELD OF THE INVENTION

The invention relates to a lighting device for providing light to be used in a photochemical reaction, to the use of the lighting device for triggering a photochemical reaction, to a photochemical reactor comprising the lighting device and to a method used by the lighting device.

### BACKGROUND OF THE INVENTION

The reactions of substances or mixtures to an irradiation with light in specific wavelengths, i.e. photochemical reactions, are today widely used for large scale production of substances, like vitamin A. To provide the light necessary for the photochemical reaction, often xenon gas discharge lamps or mercury lamps are used. However, these lamps have the drawback of a very high energy consumption and a high heat production, which results in the necessity to provide elaborate cooling, shielding and explosion protection when used in the context of a photochemical reaction.

Alternatively, it has been proposed to use LEDs, in particular, high power LEDs, for providing the light for a photochemical reaction. However, also LEDs, in particular, high power LEDs, produce heat, although not on the same scale as gas discharge lamps or mercury lamps. But, in contrast to discharge lamps and mercury lamps, LEDs are very sensitive to heat and can be damaged if the heat is not transported away from the LED. Forthe purpose of cooling LEDs, it is known to contact a circuit board on which an LED is provided with a heat sink to transport the heat produced by the LED over the contact of the LED with the circuit board and the contact of the circuit board with the heat sink away from the LED. Generally known realizations of a heat sink are air or water based cooling systems in which air or water is provided continuously to a construction element in thermal contact with the circuit board and thus with the LED to transport the heat away from the LED.

However, when trying to apply LEDs, in particular, high power LEDs, to a large scale photochemical production process, these cooling systems have shown to be very ineffective. In particular, if the LEDs should be applied in the context of large scale production processes, a large number of LEDs or an LED with a high lighting power is needed. It has been found that under these circumstances known cooling systems, in particular, cooling systems with a construction element, have to be dimensioned much larger than usual. Thus, respective production systems become bulky and in many cases too large for the available space. The dimension of the cooling system becomes in particular relevant, since LEDs generally will not survive temperatures substantially above 100° C., wherein in systems for large scale photochemical reaction processes such temperatures can be easily reached.

Thus, it would be advantageous to provide an LED with an improved heat transport system that allows for a long-term effective and safe application of the LED in the context of providing light for a photochemical reaction, wherein the heat transport system shall be adapted to be long-term permeable for light emitted from the LED.

### SUMMARY OF THE INVENTION

It is an object of the present invention to provide a lighting device for providing light to be used in a photochemical reaction with an improved heat transport mechanism that allows for a long-term effective and safe use of the lighting device for providing light in the context of a photochemical reaction. It is further an object of the present invention to provide a photochemical reactor comprising the lighting device and a method for transporting heat away from an LED that is applied in the lighting device.

In a first aspect of the present invention, a lighting device for providing light to be used in a photochemical reaction is presented, wherein the lighting device comprises a) an LED unit configured to emit light to be used in the photochemical reaction, b) a housing configured to house the LED unit, wherein at least a part of the housing is transparent for light to be used in the photochemical reaction, wherein the housing is configured to contain a dielectric liquid transparent for light generated by the LED unit such that it is in direct contact with at least a part of a light emitting side of the LED unit, and c) a liquid movement arrangement configured to support a movement of the dielectric liquid such that the dielectric liquid transports heat produced by the LED unit away from the LED unit.

Since the lighting device comprises a housing configured to house the LED unit and to contain a dielectric liquid such that it is in direct contact with at least a part of the light emitting side of the LED unit and since the lighting device comprises a liquid movement arrangement that is configured to support a movement of the dielectric liquid such that the dielectric liquid transports heat produced by the LED unit away from the LED unit, the heat produced by the LED unit can be transported directly away from the LED unit. In particular, the heat does not first have to be transported through heat conduction along the contacts of the LED with the circuit board on the side opposite the light emitting side of the LED unit and the contacts of the circuit board with the heat sink. In fact, the heat can be directly absorbed by the dielectric liquid and transported away. This allows for a more effective cooling and a reduced power consumption of the lighting device. Moreover, such a lighting device is easy and safe to handle and the necessity to provide elaborate shielding and explosion protections when used in the context of photochemical reactions is avoided.

The LED unit configured to emit light to be used in the photochemical reaction comprises an LED and the structures necessary for contacting the LED to a power source. The term “LED” used in this context can also refer to organic light emitting diodes (OLEDs), an active matrix organic light emitting diode (AMOLED), or any other diode based lighting source. Preferably, the LED refers to a high-power LED that can be used with 350 mW electrical power or more. Preferably, the LED is configured to be applied with an electrical power above 1 W.

The light emitted by the LED unit is chosen such that at least a part of the light can be used in a photochemical reaction, for instance, for the synthesis of vitamin A. Preferably, the LED unit is adapted to emit light in the ultraviolet and visible part of the electromagnetic spectrum, preferably light with a wavelength between 350 and 850 nm, more preferably between 365 and 700 nm.

Generally, the LED unit can comprise more than one LED, for instance, can comprise a plurality of LEDs and the circuitry necessary for contacting this plurality of LEDs to a power source, preferably for connecting these LEDs in series. However, the plurality of LEDs can also by connected parallel to each other or can be provided with completely independent circuitry. If the LED unit is provided with a plurality of LEDs, the light spectrum emitted by the LED unit can also be generated by the plurality of LEDs, for instance, a first part of the spectrum of the light emitted by the LED unit can be emitted by a first LED, a second part of the light emitted by the LED unit can be generated by a second LED, etc. However, all LEDs provided in the LED unit can also be configured to emit substantially the same light spectrum.

The housing is configured to house the LED unit. In particular, the housing is configured such that the LED unit is not in direct contact with its environment. In a preferred embodiment, the lighting device comprises more than one LED unit, wherein in such an embodiment the housing is configured to house more than one LED unit. The housing can be made from any suitable material, for instance, plastic or metal.

At least a part of the housing is transparent for light to be used in the photochemical reaction. The transparent part of the housing is preferably provided such that the light can be directly emitted by the LED unit through the transparent part, for instance, the transparent part of the housing can be provided on the light emitting side of the LED unit. However, the transparent part can also be provided arbitrarily, wherein in this case a reflector can be provided as part of the lighting device in the housing or integrated with the housing in order to reflect the light generated by the lighting unit in the direction of the transparent part of the housing. Generally, a substance can be regarded as being transparent for a specific wavelength, if the substance does not show any substantial absorption in that specific wavelength. For example, if light in the ultraviolet and visible spectrum is used in the photochemical reaction, the housing can be made from a material that is transparent to ultraviolet and visible light. However, if only a part of the light spectrum emitted by the LED unit should be used in a photochemical reaction, the transparent part of the housing can also only be transparent for this part of the light spectrum emitted by the LED unit such that the housing can act as a filter for the light provided by the LED unit. Preferably, the transparent part of the housing is made from glass, however, it can also be made from a transparent plastic. All parts of the housing that are not transparent can be made from any suitable material for housing the dielectric liquid, for instance, from glass, metal, plastic, etc. Preferably, a part of the housing not being transparent is made from a reflective material that allows to reflect light generated by the LED unit in the direction of the transparent part of the housing to maximize the light yield of the lighting device. Preferably, the transparent part of the housing and the LED unit and, optionally, also reflective parts of the housing, are arranged such that light emitted by the LED unit strikes the transparent part with an incidence angle smaller than the angle of total internal reflection of the transparent part. This increases the light efficiency of the lighting device.

The housing is further configured to contain a dielectric liquid transparent for light to be used in the photochemical reaction. In particular, the housing is made from a material that does not react with the dielectric liquid and is further configured such that it is impermeable for the dielectric liquid. Moreover, the housing is configured such that the dielectric liquid, when present in the housing, is in direct contact with at least a part of a light emitting side of the LED unit, preferably, with at least a part of the LED itself. For example, the housing is configured such that it provides a volume surrounding a light emitting part of the LED unit comprising the LED itself, wherein the volume can be filled by the dielectric liquid when present in the housing. A light emitting side of the LED unit refers to a side of the LED unit at which light generated by the LED of the LED unit is emitted. For example, if the LED unit comprises an LED and circuitry for connecting and further for holding the LED that is attached at one side of the LED, the LED unit is generally configured to emit light to at least one side not in contact with the circuitry or other attachment means that might hinder the light generated by the LED. Thus the light emitting side of the LED unit can be defined not only by the LED of the LED unit itself but also by other components that can be part of the LED unit like, reflector parts, circuitry, attachment means, mounting boards, etc.

Further, the lighting device comprises a liquid movement arrangement that is configured to support a movement of the dielectric liquid such that the dielectric liquid transports heat produced by the LED unit away from the LED unit. In a preferred embodiment, at least a part of the housing is integrated with the liquid movement arrangement. In particular, the part of the housing that forms a volume around the part of the LED unit in direct contact with the dielectric liquid can be integrated with the liquid movement arrangement. However, the liquid movement arrangement can also be attached to the housing and not be integrated with the housing. In order to support a movement of the dielectric liquid, the liquid movement arrangement and optionally a part of the housing integrated with the liquid movement arrangement can be configured to support a movement of the dielectric liquid introduced by the heating of the dielectric liquid by the part of the LED unit in direct contact with the dielectric liquid. For example, the liquid movement arrangement and optionally the part of the housing integrated with the liquid movement arrangement can be configured such that they support a convective movement of the dielectric liquid that allows to transport heat away from the part of the LED unit in direct contact with the dielectric liquid. Such a convective movement can be supported by providing the liquid movement arrangement and optionally the part of the housing integrated with the liquid movement arrangement in a form and dimension that do not hinder the convective motion. For example, based on the viscosity, a temperature difference and the boundary conditions between the dielectric liquid and the housing, liquid movement arrangement, and/or part of the LED unit in direct contact with the dielectric liquid, a shape, for instance, an aspect ratio, of the liquid movement arrangement and optionally the part of the housing integrated with the liquid movement arrangement are adapted such that convective motion is supported. Such a shape can, for instance, be determined by utilizing computational fluid dynamics (CFD) simulations or by experiments.

Preferably, the liquid movement arrangement comprises a liquid flow source or is configured to be connected to a liquid flow source configured to move the dielectric liquid. The liquid flow source can be, for instance, a pump or any other means that allow to introduce a movement into the dielectric liquid. The liquid movement arrangement can then provide means connecting a dielectric liquid provided in the housing of the lighting device with the liquid flow source. For example, the liquid movement arrangement can comprise circuits, ducts, pipes, etc. for supporting the liquid flow to and from the liquid flow source. Moreover, if the liquid flow source is not a direct part of the liquid movement arrangement, the liquid movement arrangement is configured to provide a connection means that allows to connect the liquid flow source to the liquid movement arrangement such that the liquid flow source can move the dielectric liquid provided in the housing.

In an embodiment, the liquid movement arrangement comprises a cooling unit outside of the housing or is adapted to be connected to a cooling unit configured for cooling the dielectric liquid. Preferably, the cooling unit is integrated with the liquid flow source such that in addition to moving the dielectric liquid, the liquid is also cooled when flowing through the liquid flow source. However, the cooling unit can also be separated from the liquid flow source and can be provided along a way of the liquid from the part of the LED unit in direct contact with the dielectric liquid to the liquid flow source or from the liquid flow source to the part of the LED unit in direct contact with the dielectric liquid. The cooling unit can be a passive or active cooling unit and can refer, for instance, to an area in which a cooling medium is brought in thermal contact with the dielectric liquid, wherein the medium can be air, water, etc. For example, if water is used for cooling the dielectric liquid it is preferred that a heat exchanger is provided such that the water does not get into direct contact with the dielectric liquid to prevent mixing of the dielectric liquid and the water. If air is used as cooling medium the heat exchanger can also allow a direct contact of the air and the dielectric liquid. Preferably, the dielectric liquid is provided in a closed circuitry with no direct contact with the environment outside of the circuitry.

In a preferred embodiment, the lighting device further comprises the dielectric liquid in the housing. Generally, the dielectric liquid can be any liquid substance that comprises a dielectric property and is transparent for at least light with wavelengths that should be used in the photochemical reaction. However, the dielectric liquid can also be transparent to the complete spectrum emitted by the LED unit. Preferably, the dielectric liquid is transparent for ultraviolet and visible light, more preferably to light with a wavelength between 350 to 850 nm, even more preferably between 365 to 700 nm. However, the dielectric liquid can also comprise a transparency specific to the wavelengths that are utilized in the photochemical reaction, such that the dielectric liquid acts as filter for the light emitted by the LED unit.

In a preferred embodiment, the dielectric liquid comprises a refraction coefficient substantially similar to the refraction coefficient of the transparent part of the housing. In this context, the term ,,substantially similar” refers to a value of the refraction coefficient lying within an interval of ± 20%, more preferably ± 10%, even more preferably ± 5% around the refraction coefficient of the transparent part of the housing. This has the advantage that no strong refraction and reflection effects at the interface between the dielectric liquid and the transparent part of the housing have to be taken into account when providing the light to a photochemical reactor. However, in other embodiments the refraction coefficient of the dielectric liquid can differ from the refraction coefficient of the transparent part of the housing. Preferably, the dielectric liquid comprises a refraction coefficient different from the refraction coefficient of air. This allows to minimize reflection losses at the interface between the dielectric liquid and the transparent part of the housing. Preferably, the refraction coefficient of the dielectric liquid lies between 1.2 and 1.7, more preferably between 1.35 and 1.55.

In a preferred embodiment, the dielectric liquid is adapted to be movable by the liquid movement arrangement in a temperature range from -35° C. to 150° C., preferably from -20° C. to 100° C. In this context, the movability of the dielectric liquid refers to the dielectric liquid comprising a viscosity that still allows a movement of the dielectric liquid away from the LED unit such that the LED unit can be cooled. Providing a dielectric liquid that can still be moved in a temperature range well below 0° C. allows a strong cooling of the LED unit leading to a higher efficiency of the LED and a lower power consumption of the LED unit. Further, the lifetime of the LED unit can be increased when operating the LED unit at low temperatures. Moreover, it allows to also apply the lighting device to photochemical reaction settings in which the reaction temperature has to be kept low, for instance, below 0° C.Preferably, the dielectric liquid comprises a flash point above 100° C., more preferably, above 150° C., even more preferably, above 250° C., even more preferably, above 300° C., in order to minimize the ignition hazard. In particular, in cases of a failure of the dielectric liquid flow, a respectively high flash point allows to minimize the risk of ignition of the liquid. Preferably, the dielectric liquid comprises in the temperature range at which the lighting device is operated a viscosity that allows for an easy movement of the dielectric liquid and prevents the application of high forces on the LED unit. Preferably, the dielectric liquid comprises a viscosity below 10⁶ mPas, more preferably below 100 mPas, even more preferably below 10 mPas.

In an embodiment, the dielectric liquid is silicone oil or mineral oil. Preferably, the dielectric liquid is silicone oil, more preferably a linear polydimethylsiloxane polymer or a polydimethylsiloxane. However, the dielectric liquid can also be any other liquid that comprises a dielectric property and a respective transparency, wherein the dielectric liquid comprises preferably at least one of the additional characteristics described above, most preferably, comprises an ignition temperature above 150° C. In a most preferred embodiment, the dielectric liquid comprises an ignition temperature above 150° C., is movable by the liquid movement arrangement in a temperature range from -35° C. to 150° C., comprises a refraction coefficient of the dielectric liquid between 1.35 and 1.55, and comprises a viscosity below 100 mPas. In a further most preferred embodiment the dielectric liquid comprises a heat capacity above 1.55 J/gK, an ignition temperature above 200° C., more preferably above 290° C., a viscosity below 60 mm²/s, optical transparence above 98% at 1 cm layer width in a wavelength range of 400 to 700 nm, a volume resistance above 10¹²Ω cm, and a heat conductivity above 0.13 W/mK. For example, a respective Polydimethylsiloxan, like Korasilon MKI 501, oil could have these characteristics and has shown to be advantageous. In an even more preferred embodiment, the dielectric liquid with these characteristics is a silicone oil. In particular, in applications referring to the triggering and/or maintaining of a photochemical reaction it has been found that a dielectric liquid with these characteristics is advantageous. However, the dielectric liquid can also comprise any other combination of the characteristics described above in detail, wherein based on the application any of the possible combinations might provide an advantage.

In an embodiment, the LED unit comprises an LED and a mounting board, wherein the LED is mounted to a first side of the mounting board, and wherein the mounting board forms at least a part of the housing such that the dielectric liquid is in direct contact with the LED on the first side of the mounting board. In particular, the first side of the mounting board can be regarded as forming the light emitting side of the LED unit. In an embodiment, the mounting board is a circuit board on which the LED is mounted and that further provides an electric circuit for contacting the LED to a power source. In such an embodiment, the LED unit can be regarded as a surface mounted device LED (SMD-LED). However, in other embodiments, the mounting board can simply be utilized for mounting the LED, wherein the contacts for contacting the LED to a power source are not provided as part of the mounting board, but are provided separately. In a preferred embodiment, the mounting board comprises a circuit board to which the LED is electrically contacted and a mounting plate on which the circuit board is mounted. Preferably, the LED, the circuit board and the mounting plate are in thermal contact with each other, such that heat produced by the LED can be transported through the thermal contact.

The mounting board can have any suitable shape for a specific arrangement or application. For example, the mounting board can have a rectangular or circular shape, or can comprise a curved shape in three dimensions, for instance, to additionally support a reflector that allows to reflect the light provided by the LED in a specific direction. This has the advantage that the mounting board can be used for mounting the lighting device, for instance, in a photochemical reactor. Preferably, the mounting board is at least partially made from a metal, preferably aluminium, such that the metal part of the mounting plate is in thermal contact with the LED.

In an embodiment, an additional cooling unit is provided on a second side of the mounting board opposite the first side such that heat is transported away from the second side of the mounting board. The additional cooling unit can refer to a known LED cooling unit, for instance, a known LED air or water cooling system. This embodiment has the advantage that the LED is not only cooled by the dielectric liquid but also by an additional cooling unit provided in thermal contact with the LED. Moreover, such a system allows for a fail-safe construction such that each of the cooling systems can be configured to provide a complete cooling of the LED in case that one of the cooling systems fails.

In an embodiment, the LED unit comprises an LED and a mounting board, wherein the LED is mounted to a first side of the mounting board, and wherein the mounting board is arranged in the housing such that the dielectric liquid is in direct contact with at least a part of the first side of the mounting board and at least a part of a second side of the mounting board opposite the first side. In particular, the first side of the mounting board can be regarded as forming the light emitting side of the LED unit. This embodiment has the advantage that the dielectric liquid can at least flow along both sides of the mounting board, preferably along all sides of the mounting board, thus providing a very effective cooling to the LED unit.

In an alternative embodiment, the LED unit does comprise an LED mounted on mounting wires that can also be used as conductors for contracting the LED to a power source. The housing can in this embodiment be adapted to house the complete LED unit such that the dielectric liquid is in contact with the LED and with parts of the mounting wires, preferably with the parts of the mounting wire that are contacted with the LED. In this embodiment the mounting board is omitted.

In a further aspect, the invention refers to the use of a lighting device according to any of above described embodiments as a light source in a photochemical reaction, wherein the light emitted by the lighting device is used to trigger and/or maintain a photochemical reaction in a medium provided in a photochemical reactor.

In a particular preferred embodiment, the lighting source is used for initiating and/or maintaining a photochemical reaction. In particular, the lighting device is used for isomerizing vitamin A. More preferably, the LED unit is adapted to emit quasi-monochromatic light in a range from 460 nm to 580 nm and the lighting device comprising this LED unit is used for irradiating a reaction mixture comprising at least one retinoid compound, inorganic solvent and a photo sensitizer. However, the lighting device can also be used for initiating and/or maintaining other photochemical reactions, wherein the wavelength of the light provided by the LED unit can be chosen in accordance with pre-knowledge about the wavelengths of light necessary for initiating and/or maintaining the photochemical reaction.

In a further aspect of the invention, a photochemical reactor is presented, wherein the reactor comprises a) a reaction chamber configured to contain a medium as basis for the photochemical reaction, and b) a lighting device according to any of the above described embodiments, wherein the light emitted by the lighting device triggers and/or maintains the photochemical reaction of the medium. The reaction chamber can refer to any volume that is adapted to contain the medium that forms a basis for the photochemical reaction. In an embodiment, the lighting device can be provided inside the reaction chamber such that the medium, preferably, the reaction mixture is in direct contact with at least the transparent part of the housing of the lighting device. Alternatively, the lighting device can be arranged outside of the reaction chamber, wherein in this embodiment the reaction chamber comprises at least a part that allows the light provided by the lighting device to enter the reaction chamber for triggering and/or maintaining the photochemical reaction.

In an embodiment, the reactor comprises a first conduit and a second conduit, wherein the first conduit is arranged inside the second conduit, wherein the reaction chamber is formed by the first conduit and the lighting device is arranged in the volume between the first conduit and the second conduit such that the light provided by the lighting device is radiated into the first conduit, or wherein the reaction chamber is formed by the volume between the first conduit and the second conduit and the lighting device is arranged inside the first conduit such that the light provided by the lighting device is radiated into the volume between the first conduit and the second conduit. The first and the second conduit can each be understood as an arrangement of pipes, tubes and/or vessels that are suitable for containing the reaction mixture or the lighting device, respectively. The first and the second conduit can have an arbitrary suitable cross section, for instance, a rectangular cross section, a circular cross section, an elliptical cross section, etc. In a preferred embodiment, the first conduit and the second conduit each comprise the form of a tube with a circular cross section. In this embodiment, it is further preferred that the first conduit and the second conduit are arranged such that the conduit walls are parallel to each other. More preferably, the first conduit and the second conduit are arranged such that a centerline of the first conduit and a centerline of the second conduit coincide. The lighting device can be provided in the first or second conduit, respectively, for instance, by attaching the lighting device to a wall of the first conduit or second conduit, respectively.

In a preferred embodiment, at least a part of the first conduit forms at least a part of the housing of the lighting device. In particular, the part of the first conduit formed by the part of the housing of the lighting device refers to the transparent part of the housing of the lighting device. For example, the first conduit can be formed from a transparent material. At least a part of the housing of the lighting device and optionally of a part of the liquid movement arrangement integrated with the housing can be formed by the first conduit. If the lighting device is arranged inside the first conduit, the first conduit can form substantially the complete housing of the lighting device, wherein the dielectric liquid can then be moved through the first conduit for cooling the lighting device. If the lighting device is arranged in the volume formed by the first and the second conduit, a part of the housing of the lighting device can be formed by the first conduit and another part of the housing of the lighting device can be formed by the wall of the second conduit. The dielectric liquid in this embodiment can then move through the volume between the first conduit and the second conduit for removing the heat from the LED unit.

In a preferred embodiment, the lighting device comprises more than one LED unit, wherein the LED units are arranged in regular intervals along a circumference of the first conduit or the second conduit, respectively, such that each of the plurality of LED units can radiate light into the reaction chamber. However, alternatively each lighting device can comprise only one LED unit, wherein in this case it is preferred that the reactor comprises a plurality of lighting devices being arranged regularly around the circumference of the first conduit or the second conduit, respectively, such that each of the lighting devices can emit light into the reaction chamber. It is further preferred that the LED unit of a lighting device comprises more than one LED, wherein the LEDs are arranged in the LED unit, preferably, along a line, such that the lighting device comprising the LED unit can be arranged in the first conduit or in the volume between the first and the second conduit such that the line formed by the LED units is parallel to a centerline of the first conduit.

In a further embodiment, a third conduit can be formed between the first conduit and the second conduit such that a volume is formed between the first conduit and the third conduit and a further volume is formed between the third conduit and the second conduit, wherein, if the lighting device is arranged in the volume between the first conduit and the second conduit, the lighting device can be arranged in the volume formed between the first conduit and the third conduit or preferably in the volume formed between the third conduit and the second conduit. The volume between the first and the third conduit or between the third and the second conduit, which is not used by the lighting device, can be configured to contain an additional medium, like water, air, etc., for providing an additional cooling to the volume containing the lighting device and/or the reaction chamber. Moreover, this embodiment allows to realize the reactor utilizing separate components that can be easily separated, for instance, for service or replacement purposes. For example, the first and the third conduit can be formed as one component and the second conduit can be formed as a separate component, wherein the two components are only attached to each other by attachment means such that they can be easily separated for service or replacement of one component. In an embodiment comprising a third conduit, the third conduit can form a part of the housing of the lighting device. For example, if the lighting device is arranged in the volume formed by the third conduit and the second conduit, at least the third conduit can form a part of the housing of the lighting device.

In a preferred embodiment, the reactor comprises the first conduit and the second conduit, wherein the first conduit is arranged inside the second conduit, wherein the LED unit is arranged in the volume between the first conduit and the second conduit. Preferably, the reaction chamber is formed by the first conduit or the first conduit is adapted to contain the reaction chamber. In this case it is preferred that the LED units are arranged such that the light provided by the lighting device is radiated into the first conduit and thus into the reaction chamber. However, alternatively, the reaction chamber can be arranged outside the second conduit, for instance, such that it surrounds the second conduit. In this case it is preferred that the LED units can also be arranged such that the light provided by the lighting device is radiated outside of the second conduit and thus into the reaction chamber. Preferably, the first and second conduit both form a part of the housing of the LED unit. Moreover, it is preferred that the LED unit and the first and second conduit are arranged such that the dielectric liquid can contact the LED unit on the light emitting side and on the side opposite the light emitting side, in particular, can contact the LED unit on all sides. It is further preferred that a plurality of LED units is provided within the volume between the first and second conduit and that each LED unit comprises a plurality of LEDs. For example, the LED units comprising a plurality of LEDs can be configured as LED stripes that are arranged parallel to the wall of one of the conduits and are arranged either circumferential or parallel to the centreline of one of the conduits. Moreover, it is preferred that the distance between the first conduit and the second conduit is as small as possible, i.e. substantially refers to the distance necessary for allowing for a presence of the one or more LED units between the conduits without contact between the one or more LED units and the conduit surfaces. In a preferred embodiment, the distance between the conduits is smaller than 30 mm, more preferably, smaller than 20 mm, even more preferably, smaller than 10 mm. A respective distance between the conduits has the advantage that the dielectric fluid will flow as fast as possible through the volume containing the LED unit and thus allows for a very effective cooling of the LED unit.

In a preferred embodiment, the liquid movement arrangement comprises a ring nozzle, wherein the ring nozzle is arranged at at least one end of the first and second conduit such that the ring nozzle closes the volume between the first and second conduit at the end, wherein the ring nozzle is adapted to guide the dielectric liquid from a connector arrangement adapted to provide the dielectric liquid to the ring nozzle to the volume between the first and second conduit comprising the one or more LED units. Preferably, the ring nuzzle comprises arrangement means that allow to arrange the first and second conduit in direct contact with the ring nozzle such that the contact is impermeably for the dielectric liquid. For example, the ring nozzle can comprise two grooves for receiving an end part of the first and second conduit, respectively. Thus, the grooves provide a guidance for the arrangement of the first and second conduit. Preferably, a seal is provided as part of the arrangement means within the grooves. Moreover, it is preferred that the grooves further comprise a notch provided with an O-ring seal for sealing the volume between the two conduits and the ring nozzle. In particular, using an O-ring seal has shown to be advantageous for preventing a leakage of dielectric fluid, due to the flexibility of the O-ring seal allowing to compensate small discrepancies in the height of the first and second conduit.

In a preferred embodiment the ring nozzle comprises a circular volume with a plurality of openings that connect the volume containing the one or more LED units with the circular volume of the ring nozzle, wherein the connector arrangement is adapted to provide the dielectric liquid into the circular volume. Preferably, the connector arrangement is arranged tangential to the circular volume of the ring nozzle and is thus configured such that the dielectric liquid flows tangentially into the circular volume. Moreover, it is preferred that the connector arrangement is configured as an injector providing an acceleration to the dielectric liquid when passing the connector arrangement and entering the circular volume. This configuration of the connector arrangement has the advantage that the dielectric liquid can be evenly distributed into the circular volume with a low pressure increasing the security of the ring nozzle arrangement.

In a preferred embodiment the circular volume comprises a shape that is narrower at the side of the conduits, i.e. the side of the plurality of openings, than at the opposite side. Or defined in another way, in a cross section through the circular volume along a plane parallel to a centreline of the conduits, the circular volume comprises a substantially triangular shape. This shape of the circular volume of the ring nozzle has the advantage that a jet effect can be applied to the dielectric liquid when leaving the circular volume through the openings leading to an accelerating of the dielectric liquid in the direction of the volume between the two conduits. Moreover, the shape allows for a higher stability of the ring nozzle, in particular, in the context of a 3D printing of the ring nozzle.

Preferably, the ring nozzle is adapted to be produced in a 3D printing process. For example, the ring nozzle can be made completely or partially of a printable steel or aluminium. Moreover, the ring nozzle can also be made completely or partially of a printable polymer. Preferably, the ring nozzle is printed in a photo curing technique from a liquid. In this case it is preferred that the ring nozzle is printed from a material mixture comprising methacrylic acid esters and photo initiators, more preferably comprising methacrylic acid esters, photoinitiators, proprietary pigments and additives, even more preferred comprising methacrylic and acrylic acid esters and photoinitiators.

In a preferred embodiment the ring nozzle comprises electrical contacting means configured to provide an electrical power supply to the one or more LED units, wherein the electrical contacting means are arranged to be in direct contact with the dielectric fluid in the circular volume of the ring nozzle. Preferably, the electrical contacting means have anti-capillary characteristics. For example, the electrical contacting means can comprise conductors without interspaces that potentially have a capillary effect on the dielectric liquid in contact with the conductors. For example, the conductors can be formed from a conductive bar. This allows to avoid a leaking of the dielectric liquid through the electric contacting means. Additionally or alternatively, the electric contacting means can be provided in form of one or more electric contact plates within the ring nozzle that can be electrically contacted from within and without the circular volume of the ring nozzle. In this case the electrical contacting means can further comprise conductors contacting the one or more contact plates to the one or more LED unit. In this example, anti-capillary characteristics are not necessary for the conductors contacting the contact plate, since the conductors have no contact to the outside of the ring nozzle. Thus the conductors can be realized as litz wire.

In a preferred embodiment the reactor comprises a ring nozzle at each end of the first and second conduit as described above, wherein in this case one ring nozzle acts as a fluid injector for injecting the dielectric fluid into the volume between the conduits and the second ring nozzle acts as a collector for collecting the dielectric fluid after having flown through the volume between the conduits for cooling the LED units. Preferably, the ring nozzles on both sides comprise the same amount of openings to the volume between the conduits for supporting a straight and parallel flow of the dielectric liquid between the two conduits from one ring nozzle to the other. However, in other embodiments, only one ring nozzle can be provided acting as injector, whereas the collector is realized by a simple ring collector collecting and guiding the dielectric fluid out of the volume between the conduits.

In an embodiment, the ring nozzle can be segmented by segmenting the circular volume such that each segment of the circular volume comprises at least one opening connecting the segment to the volume between the conduits. In particular, in this embodiment it is preferred that the volume between the conduits is also segmented in correspondence with the segmentation of the circular volume, wherein in this case each segment of the volume between the conduits can comprise at least one LED unit. However, in some embodiments also some segments of the volume between the conduits can comprise no LED unit and thus refer to empty segments. It is further preferred that the segments of the circular volume and of the volume between the conduits are arranged such that the dielectric liquid flows, after having past one segment of the volume between the conduits, to the next segment of the ring nozzle. In particular, the segmented ring nozzle and the segmented conduits can be configured such that the dielectric fluid can flow more than once along the LED units from one end of the conduit to the other. Thus, the distance between the injecting of the dielectric fluid into the ring nozzle and the collecting of the dielectric fluid for leaving the reactor can be increased and thus also, at the same pressure difference, the flow velocity can be increased allowing for an improved cooling of the LED units.

In an alternative embodiment, each segment of the circular volume can be provided with its own connector arrangement for providing the dielectric fluid to the respective segment. In this case a segmentation of the conduits can also be provided, but can also be omitted.

Preferably, the ring nozzle comprises a central opening surrounded by the circular volume, wherein the central opening is dimensioned to allow an arrangement of the reactor chamber through the central opening. This allows for an easier construction of the reactor. Moreover, it is preferred that the first conduit is formed integrally with the ring nozzle, for instance, by utilizing 3D printing techniques. Also this features allows for an easier and more stable construction of the reactor.

In a further aspect of the invention, a method for transporting heat away from an LED unit is presented, wherein the method comprises the steps of a) providing a housing that is configured to house the LED unit, b) providing a dielectric liquid in the housing such that it is in direct contact with at least a part of the LED unit, and c) moving the dielectric liquid in order to remove heat from the LED unit. In particular, the lighting device as described above is adapted to carry out the method for transporting heat away from an LED unit.

It shall be understood that the lighting device, the lighting device used as a light source in a photochemical reaction, the photochemical reactor comprising the lighting device, and the method for cooling an LED unit as provided by the lighting device have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIGS. 1a and 1b show schematically and exemplarily an embodiment of a lighting device,

FIGS. 2a and 2b show schematically and exemplarily an arrangement of a lighting device with respect to a photochemical reaction chamber,

FIGS. 3a to 4d show schematically and exemplarily an embodiment of a photochemical reactor comprising a lighting device,

FIG. 5 shows a flowchart exemplarily illustrating an embodiment of a method for cooling an LED unit provided in the lighting device, and

FIGS. 6 and 7 show schematically and exemplarily an example of a ring nozzle that can be utilized with a chemical reactor.

### DETAILED DESCRIPTION OF EMBODIMENTS

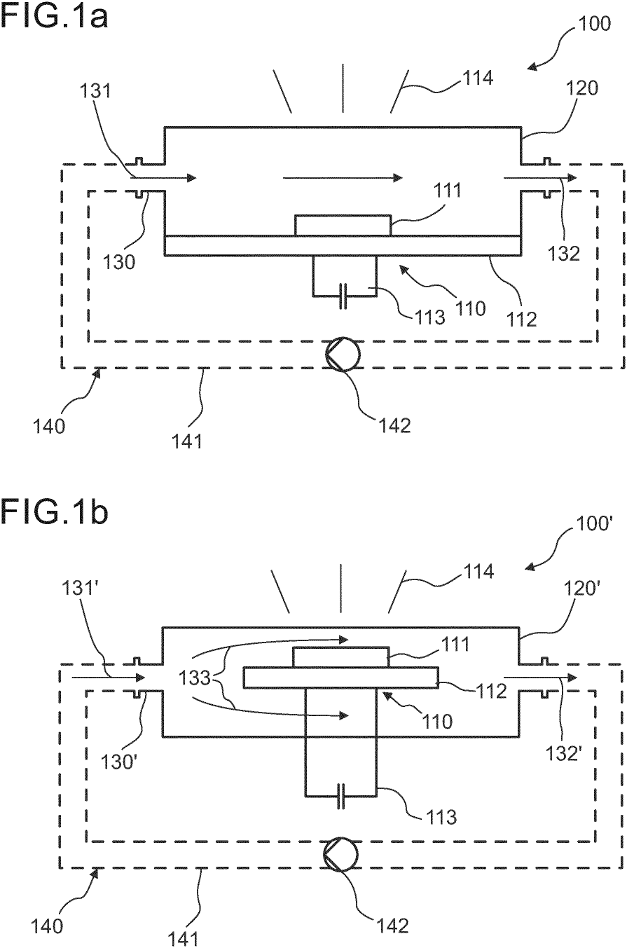

FIG. 1a shows schematically and exemplarily an embodiment of a lighting device to be used in a photochemical reaction. The lighting device 100 comprises an LED unit 110, a housing 120 and a liquid movement arrangement 130.

In this exemplary embodiment, the LED unit 110 comprises LED 111 and a mounting board 112, wherein the mounting board 112 is adapted to provide means that allow to connect LED 111 to a power source 113. The mounting board 112 hence refers in this example to a circuit board adapted to provide the necessary circuitry for driving a high-power LED 111. However, in other embodiments, the mounting board can simply refer to a board on which LED 111 can be mounted, wherein the contacting means for contacting LED 111 to a power source 113 are not provided as part of the mounting board 112. The LED 111 is adapted to provide light 114 that can be used in a photochemical reaction.

The housing 120 of lighting device 100 is in this embodiment configured to house the LED unit 110 such that the mounting board 112 forms a lower part of the housing 120. Further, in this embodiment the housing comprises a transparent part, for instance, the upper half of the housing 120, which is transparent for light 114 that should be used in a photochemical reaction. Moreover, the housing 120 is configured such that at least a light emitting part of the LED unit 110 is in direct contact with a dielectric liquid, when present in the housing 120. In particular, the LED 111 and a part of the first side of the mounting board 112 on which the LED 111 is mounted and which can be considered as the light emitting side of the LED unit in this embodiment are in direct contact with the dielectric liquid.

In this example the housing is already provided with the dielectric liquid. However, the dielectric liquid can also be provided as part of a liquid flow source to the housing when the housing is connected to the liquid flow source. The dielectric liquid provided in the housing 120 of the lighting device 100 is preferably a silicone oil or a mineral oil. Generally, the provided dielectric oil is chosen to be transparent at least for the light 114 provided by the LED unit 110 that should be used in the photochemical reaction. In particular, the dielectric liquid provided in the housing of the lighting device 100 does not substantially absorb or reflect light of a wavelength provided by the LED unit 110 that should be used in the photochemical reaction. In a preferred embodiment, the dielectric liquid is substantially transparent for the complete light, i.e. for the complete spectrum, emitted by the LED unit 110. It is preferred that the dielectric liquid provided in the housing 120 comprises a substantially similar refraction coefficient as the transparent part of the housing 120. In particular, a refraction coefficient lying between 1.35 and 1.55 is preferred for the dielectric liquid, since most transparent housing materials will also comprise a refraction coefficient in this interval.

Experiments have shown that, in particular, a dielectric liquid chosen from the group containing Element14 PDMS High Viscosity Oils, Baysilone® Fluids M and KORASILON® Oils M are suitable as dielectric liquid. However, also other silicone or mineral oils might be utilized as dielectric liquids in the lighting device 100 and might comprise characteristics that can be used to advantage.

In this example the housing 120 is integrated with the liquid movement arrangement 130. The liquid movement arrangement 130 supports the movement of the dielectric liquid through the housing 120 such that the dielectric liquid can transport head produced by the LED unit away from the LED unit 110. In this exemplary embodiment, the liquid movement arrangement 130 comprises means for supporting an inflow 131 and an outflow 132 of a dielectric liquid with respect to the housing 120 such that the dielectric liquid can come into direct contact with the LED unit 110. In this exemplary embodiment, the dielectric liquid can come into direct contact with the LED 111 and a first side of the mounting board 112 on which the LED 111 is mounted. In the embodiment shown in FIG. 1a, the dielectric liquid comes into contact with the complete first side of the mounting board 112. However, in other embodiments the housing 120 can be configured such that the dielectric liquid only comes into contact with a part of the first side of the mounting board 112, only a part of the LED 111 or a part of both the first side of the mounting board 112 and a part of the LED 111.

In the embodiment shown in FIG. 1a, the liquid movement arrangement 130 comprises connection means that allow to connect the lighting device 100 to a liquid flow source 140. The liquid flow source 140 comprises a pump 142 providing a movement to the dielectric liquid and further the necessary circuitry for transporting the dielectric liquid from and to the connecting means of the liquid movement arrangement 130. However, in an alternative embodiment, the liquid flow source 140 can also directly be integrated as part of the liquid movement arrangement 130 into the lighting device 100, wherein in this case connecting means for connecting to the liquid flow source 140 can be omitted.

Further, a cooling unit, not shown in FIG. 1a, can be provided, for instance, as part of the liquid flow source. In this case, the cooling unit can be part of the pump 142 and/or can be part of the circuitry 141.

When used for providing light to a photochemical reaction chamber, the LED 111 is powered by the power source 113 and produces light 114 provided to the photochemical reactor. Additionally, the LED 111 produces heat that has to be transported away from the LED 111. In order to transport the heat away from the LED 111, the dielectric liquid is pumped by pump 142 through the circuitry 141 into the liquid movement arrangement 130 and the housing 120 such that it comes into direct contact with LED 111 and can transport heat produced by LED 111 away, for instance, to a cooling unit provided in circuitry 141, before again being pumped by pump 142 into the housing 120.

FIG. 1b shows a modification of the embodiment of the lighting device shown in FIG. 1a. In particular, elements of the lighting device 100′ that can be provided similar to elements already described with respect to lighting device 100 are provided with the same reference signs. The main difference between the lighting device 100 shown in FIG. 1a and the lighting device 100′ shown in FIG. 1b refers to the configuration of the housing 120′ being integrated with the liquid movement arrangement 130′. In particular, in this exemplary embodiment, the housing 120′ and the liquid movement arrangement 130′ are configured such that the dielectric liquid can come into contact with at least a part of the first side of the mounting board 112 on which the LED 111 is mounted and additionally with at least a part of a second side of the mounting board 112 opposite the first side. Thus, in this embodiment, incoming dielectric liquid 131′ can flow as indicated by arrows 133 along the first side and the second side to transport heat away from the LED unit 110 when flowing out 132′ of the housing 120′. This embodiment has the advantage that the LED unit 110 can be cooled even more effectively, since the surface area in which the LED unit 110 is in direct contact with a dielectric liquid is increased.

In both embodiments of the lighting device 100 and 100′, the mounting board 112 can comprise a mounting plate on which, for instance, a circuit board on which the LED 111 is mounted, can be provided, wherein such a mounting plate is preferably made from a metal. Alternatively, the mounting plate can be provided as not being part of the LED unit 110 but as an optional addition to the LED unit 110. This is in particular advantageous in embodiments in which the lighting device 100, 100′ comprises more than one LED unit 110, wherein in this case all LED units 110 can be mounted on the mounting plate which might then form, for instance, in the embodiment shown in FIG. 1a, a part of the housing 120 housing the plurality of LED units 110.

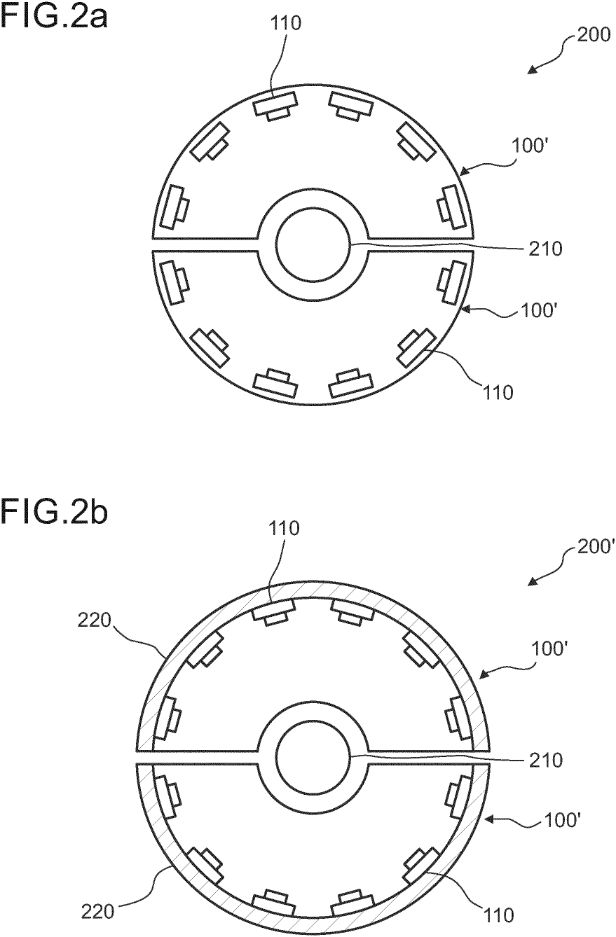

FIGS. 2a and 2b show an exemplary arrangement and configuration of lighting devices 100, 100′ providing light to a reaction chamber 210 in which a medium is provided in which a photochemical reaction should be triggered and/or maintained by the light provided by lighting devices 100, 100′. FIGS. 2a and 2b show in particular schematic cross sections through the arrangement of the lighting device and the reaction chamber.

In the arrangement 200 shown in FIG. 2a, two lighting devices based on the principles explained with respect to lighting device 100′ of FIG. 1b are provided. The lighting devices 100′ are provided in the form of half cylinders comprising a plurality of LED units 110. In accordance with the principles disclosed with respect to FIG. 1b showing lighting device 100′, the LED units 110 are arranged in the housing of lighting device 100′ in such a manner that the dielectric liquid can come into contact with a first and a second side of a mounting board of the LED units 110. Preferably, the liquid movement arrangement is configured in this embodiment such that the dielectric liquid provided within the half cylinder part of the lighting device 110 can flow in a general direction parallel to a centerline of the half cylinder, wherein the flow of the dielectric liquid in the half cylinder can be realized as a laminar or a turbulent flow.

In contrast to the arrangement 200 shown in FIG. 2a, the arrangement 200′ shown in FIG. 2b utilizes lighting devices 100 based on the principles described with respect to FIG. 1a. In particular, in the lighting devices 100 utilized in the arrangement 200′, the LED units 110 are mounted on a mounting plate 220 that forms the outer part of the housing of the lighting device 100. Preferably, the mounting plate 220 is made from a metal, wherein the LED units 110 are arranged on the mounting plate 220 in a manner such that the LED is in thermal contact with the mounting plate 220. This embodiment allows to provide an additional cooling, for instance, by providing a cooling circuitry within the mounting plate 220, to the LED units 110.

Both arrangements 200 and 200′ allow to provide light emitted by the LED units 110 through a transparent part of the housing into reaction chamber 210, wherein in this arrangement the reaction chamber 210 is at least partly formed from a transparent material.

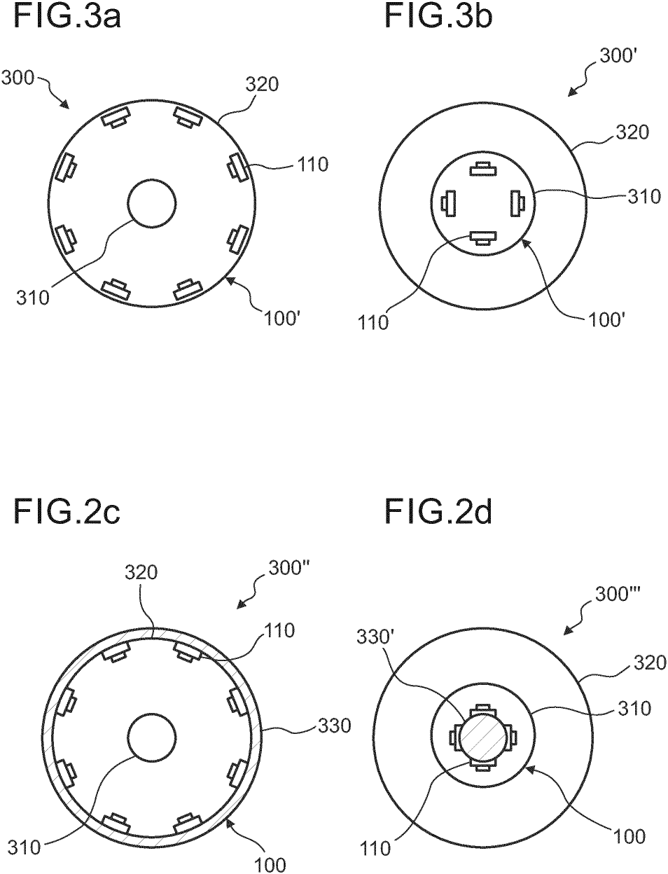

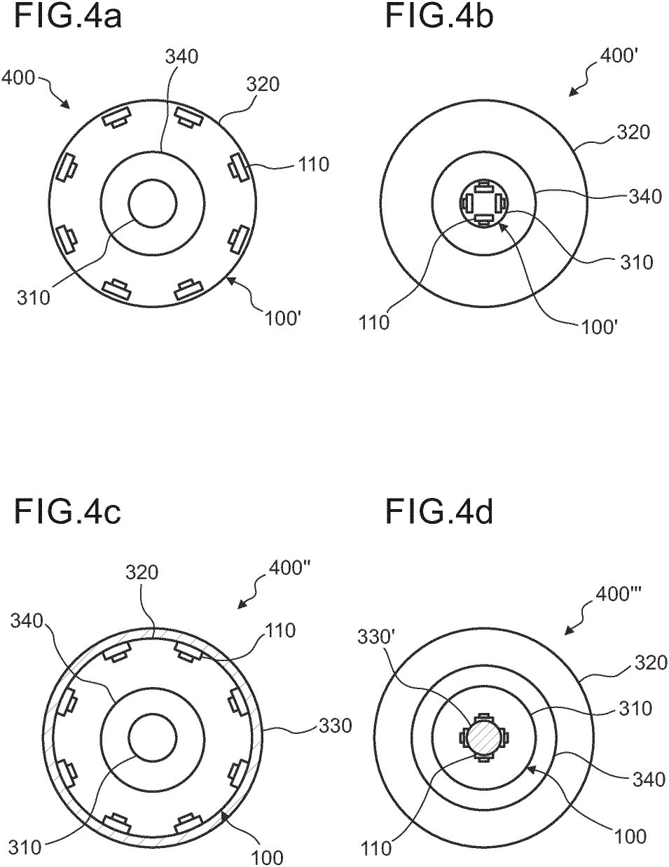

FIGS. 3a to 4d show different embodiments of a photochemical reactor integrated with a lighting device in accordance with the principles explained with respect to FIGS. 1a and 1b. In FIGS. 3a to 3d, the lighting device is integrated with a reaction chamber for forming the photochemical reactor by providing a first conduit 310 and a second conduit 320. Preferably, the first conduit 310 and the second conduit 320 are cylinder-shaped, wherein the first conduit 310 is provided inside the second conduit 320 such that the centerlines of the first conduit 310 and the second conduit 320 coincide. Moreover, in the exemplary embodiment show in FIGS. 3a to 3d, at least a part of the housing of the lighting device is formed by at least a part of the first conduit 310. For example, in FIG. 3a, at least parts of the housing of the lighting device 100′ are formed by the first conduit 310 and the second conduit 320.

In FIGS. 3a and 3b, the lighting devices are based on the principle of the lighting device 100′ as explained with respect to FIG. 1b. In particular, in both embodiments, the LED units 110 are arranged inside the housing of the lighting device 100′, such that a dielectric liquid is in direct contact with a first side of the mounting board and a second side of the mounting board of the LED units 110.

In the photochemical reactor 300 shown in FIG. 3a, the first conduit further forms at least part of the reaction chamber in which a reaction medium can be provided in which a photochemical reaction should be triggered by the light provided by the lighting device 100′. The LED units 110 are then provided within the volume formed between the first, i.e. inner, conduit 310 and the second, i.e. outer, conduit 320 such that they can emit light in the direction of the first conduit 310. Since, in this embodiment, the first conduit 310 and the second conduit 320 form at least part of the housing of the lighting device 100′, the liquid movement arrangement can be adapted such that the dielectric liquid is supported to move through the volume formed between the first conduit 310 and the second conduit 320.

FIG. 3b shows an alternative arrangement of a photochemical reactor 300′ in which the housing of the lighting device 100′ is mainly formed by the first conduit 310. Thus, in this case the liquid movement arrangement is configured to support a liquid flow through the first conduit 310, in a general direction parallel to a centerline of the first conduit 310. In this exemplary embodiment, the reaction chamber is formed by the volume between the first conduit 310 and the second conduit 320. The LED units 110 in the lighting device 100′ formed at least partially by the first conduit 310 are thus arranged such that the light emitted by the LED units 110 is provided to the outside of the first conduit 310 and thus into the volume between the first conduit 310 and the second conduit 320. In this embodiment, at least the parts of the first conduit 310 directly above the LED units 110 are formed from a transparent material.

FIGS. 3c and 3d show photochemical reactors 300″ and 300‴ similar to the photochemical reactors 300 and 300′, wherein the lighting device integrated with the reaction chamber 310 in this case is based on the principles described with respect to lighting device 100 shown in FIG. 1a. In particular, in these embodiments the LED units 110 are mounted on a mounting plate 330, preferably, made at least partly from metal.

In the photochemical reactor 300″ exemplarily shown in FIG. 3c, the mounting plate 330 forms at least part of the wall of the second conduit 320. The mounting plate 330 can be adapted, for instance, to provide a further cooling to the LED units 110, for instance, by providing cooling circuitry within the mounting plate 330. In the embodiment of the photochemical reactor 300‴ that is similar to the photochemical reactor 300′ shown in FIG. 3b, the mounting plate 330 is provided in the form of a cylinder on which the LED units 110 are mounted. Also in this embodiment, the mounting plate 330′ can be provided with a cooling unit, for instance, with a cooling circuitry within the cylinder formed by the mounting plate 330′.

FIGS. 4a to 4d refer to modified embodiments of photochemical reactors shown in FIGS. 3a to 3d, respectively. The main difference between the photochemical reactors 400, 400′, 400″ and 400‴ and the photochemical reactors 300, 300′, 300″ and 300‴ refers to providing a third conduit 340 such that an additional volume is formed between the first conduit 310 and the third conduit 340. In photochemical reactors 400 and 400″ referring to photochemical reactors 300 and 300″, the LED units 110 are then formed in the volume provided by the third conduit 340 and the second conduit 320. Thus, in these embodiments the third conduit 340 and the second conduit 320 can be regarded as forming at least part of the housing of the lighting device 100. In all embodiments shown in FIGS. 4a to 4d of the photochemical reactor, the third conduit 340 forming the additional volume between the first conduit 310 and the third conduit 340 have the advantage that in this additional volume a further medium can be provided. The medium can be, for instance, a liquid or gaseous medium. Preferably, the medium refers to air or nitrogen. In particular, if the medium in the additional volume refers to nitrogen, an explosion risk can be reduced.

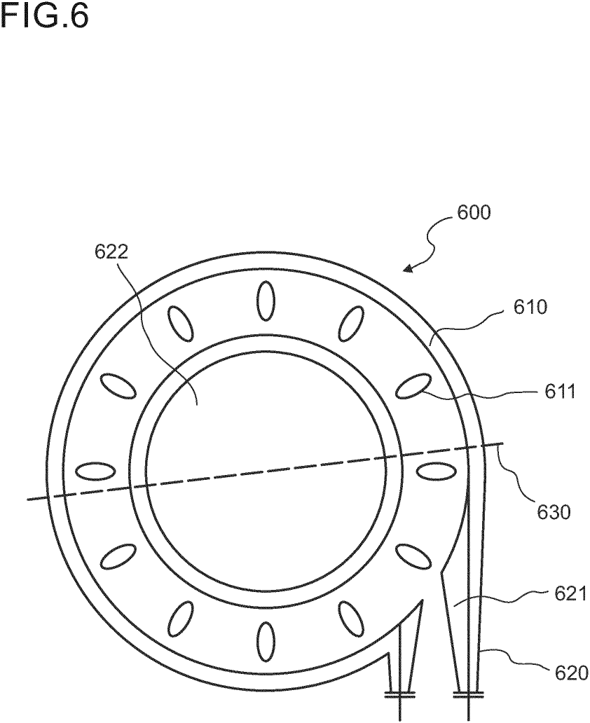

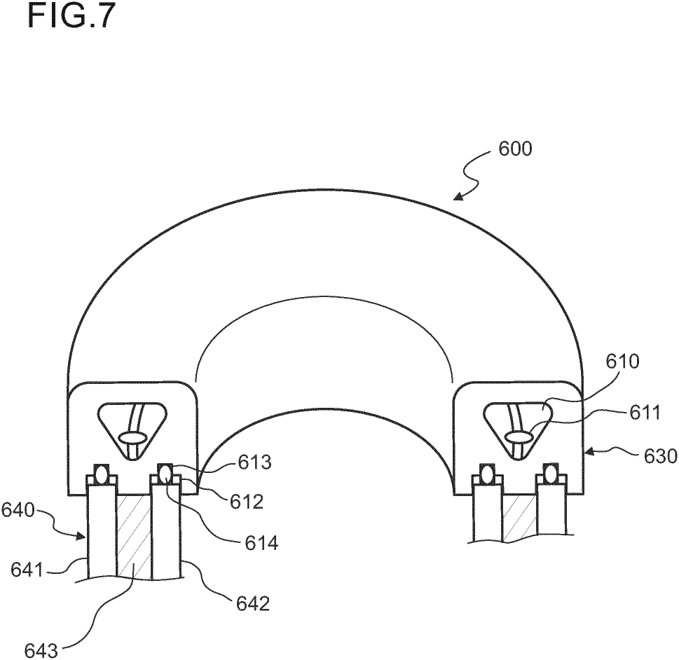

FIGS. 6 and 7 show schematically and exemplarily an example of a ring nozzle as can advantageously be utilized, for instance, in any of the embodiments of the chemical reactor explained with respect to FIGS. 3a, 3c, 4a and 4c. In particular, the ring nozzle as shown in FIGS. 6 and 7 can be employed with respect to a reactor comprises a first conduit and a second conduit, as described above, wherein the one or more LED units are arranged in the volume between the first conduit and the second conduit. For example, in these cases the ring nozzle can be arranged at at least one end of the first and second conduit such that the ring nozzle closes the volume between the first and second conduit at this side. Preferably, a ring nozzle is provided on both ends of the first and second conduit.

FIG. 6 shows a cross section of an exemplary ring nozzle 600 in a plane perpendicular to a centreline of the conduits. The ring nozzle 600 comprises a connector arrangement 620 that allows to connect the ring nozzle to a fluid source comprising the dielectric fluid, for instance, allows to connect the ring nozzle to a fluid movement arrangement as described above. For this purpose the connector arrangement 620 can be provided with any connecting means, for instance, with a screw connection, that is configured to securely and tightly connect the ring nozzle to the fluid source. Preferably, as shown in FIG. 6 the connector arrangement is arranged tangential to a circular volume 610 of the ring nozzle. Accordingly the dielectric liquid flows tangentially into the circular volume 610. This allows for a good distribution of the dielectric liquid into the circular volume 610. Further, it is preferred that the connector arrangement 620 is configured as an injector 621 providing an acceleration to the dielectric liquid when passing the connector arrangement 620 and entering the circular volume 610. The circular volume 610 is formed by the wall of the ring nozzle 600 and comprises a plurality of openings 611 into the volume between the conduits where the LED units are arranged. This circular volume 610 is further exemplary depicted in FIG. 7 and explained below. Further, shown in FIG. 6 is a central opening 622 of the ring nozzle 600 surrounded by the circular volume 610. Preferably, the central opening 622 is dimensioned to allow an arrangement of a reactor chamber through the central opening 622. In particular, the radius of the central opening 622 has substantially the same radius as a reaction chamber configured to be arranged in the first conduit. Thus allows for an easy construction of the chemical reactor.

FIG. 7 shows a cross section 630 through the ring nozzle 600 and the conduit arrangement 640 comprising the two conduits 641 and 642. In particular, in FIG. 7 the shape of the circular volume 610 can be seen. The circular volume 610 comprises a shape that is narrower at the side of the conduits 641 and 642, i.e. the side of the plurality of openings 611, than at the opposite side. Or defined otherwise, in a cross section through the circular volume 610 along a plane parallel to a centreline of the conduits 641 and 642, the circular volume 610 comprises a substantially triangular shape. Moreover, FIG. 7 shows exemplarily the arrangement means that allow to arrange the first and second conduit 641, 642 in direct contact with the ring nozzle 600 such that the contact is impermeably for the dielectric liquid in the volume 643 between the two conduits 641, 642. In this example, the ring nozzle 600 comprise as part of the arrangement means two grooves 612 for receiving an end part of the first and second conduit 641, 642, respectively. Further, the grooves 612 comprise a notch 613 provided with an O-ring seal 614 for sealing the volume 643 between the two conduits 641, 642 and the ring nozzle 600. The O-ring seal 614 is especially suitable, since it allows to compensate for small discrepancies in the heights of the end parts of the first and second conduit 641, 642.

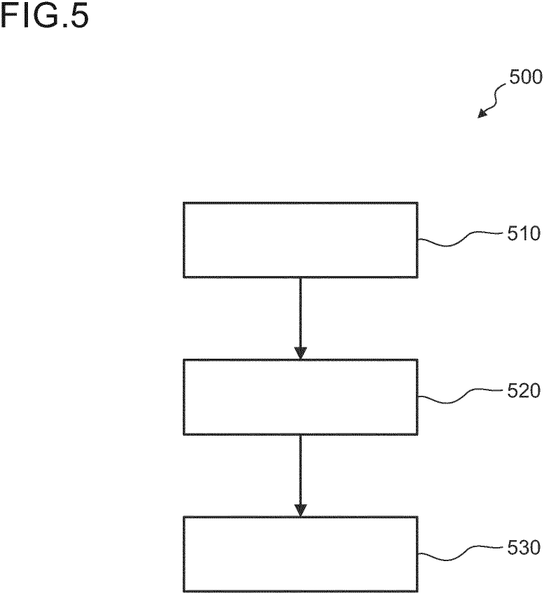

Preferably, the ring nozzle is adapted to be produced in a 3D printing process. For example, the ring nozzle can be made completely or partially of a printable steel or aluminium. Moreover, the ring nozzle can also be made completely or partially of printable polymer. FIG. 5 shows schematically and exemplarily a flowchart of a method 500 for transporting heat away from an LED unit, for instance, an LED unit as defined above. The method 500 comprises a first step 510 of providing a housing that is configured to house the LED unit. In particular, the housing can refer to one of the examples explained with respect to FIG. 1 to 4d. Further, in a second step 520, a dielectric liquid is provided in the housing such that it is in direct contact with at least a part of the LED unit according to the principles also described above. By moving in a last step 530 the dielectric liquid, the heat from the LED unit can be removed. The dielectric liquid can be moved, for instance, using a liquid movement arrangement in accordance with one of the above described embodiments.

Although in the above embodiments the liquid flow source and the liquid movement arrangement were together described as providing a pump in a closed circuit in which the same dielectric liquid is pumped from and to the LED unit, in other embodiments the liquid flow source and the liquid movement arrangement might not provide a closed circuit. For instance, in an embodiment, the liquid flow source and the liquid movement arrangement might be configured such that always new dielectric liquid is provided to the LED unit, wherein the dielectric liquid, after having been in contact with the LED unit, is provided to a waste reservoir by the liquid movement arrangement. Moreover, in other embodiments the same liquid flow source might be utilized for moving the dielectric liquid through a plurality of liquid movement arrangements and housings of a plurality of lighting devices. For example, the liquid movement arrangements of a plurality of lighting devices can be connected to one central liquid flow source moving the dielectric liquid through all the lighting devices.

Although in the above embodiments the lighting devices are provided outside of the reaction chamber, or such that the reaction chamber forms a part of the housing of the lighting devices, in other embodiments, the lighting devices can also be provided inside the reaction chamber. For example, a lighting device as described with respect to FIGS. 1a and 1b can simply be provided inside the reaction chamber such that the reaction medium is in direct contact with at least a part of the housing of the lighting device. Moreover, the one or more lighting devices can be attached to an inner wall of the reaction chamber.

Although in the above embodiments the housing was schematically shown to comprise a rectangular shape, a cylindrical shape, or a half cylindrical shape, also completely different housing shapes can be utilized. For example, dome shaped housings might be advantageous in applications in which the lighting device is provided inside a reaction chamber. Moreover, although in the above embodiments a plurality of LED units were provided in a lighting device with a housing comprising a half cylindrical shape, in another embodiment, instead of a plurality of LED units in one lighting device also a plurality of lighting devices comprising, for instance, a housing with a shape of a cylindrical segment and comprising only one LED unit, preferably, with a plurality of LEDs, can be utilized to provide light to a photochemical reactor provided as conduit in the middle of the lighting devices.

Although in the above embodiments all conduits have a cylindrical shape, in other embodiments the conduits can also comprise a rectangular cross section, an elliptical cross section or an arbitrarily formed cross section. Moreover, the conduits can also be bent, curved or comprise different radii along their length.

Although in the above described embodiments the centerlines of the conduits coincide and the walls are substantially parallel to each other, in other embodiments the conduits can comprise different shapes, can be arranged such that the centerlines deviate from each other or such that the walls of the conduits are not parallel to each other. In particular, the first and the third conduit can also be provided in a kind of meandering manner that is completely surrounded by the second conduit. Furthermore, more than one first conduit can be provided within the second conduit. For example, in such an embodiment a plurality of first conduits may form a plurality of different reaction chambers in which different reaction mixtures can be provided and irradiated by the lighting devices arranged within the second conduit surrounding the plurality of first conduits.

Although in the above described embodiments the dielectric liquid is described as a silicone or mineral oil, in other embodiments the dielectric liquid can be another dielectric substance comprising a respective transparency, wherein it is preferred that the dielectric liquid comprises a ignition temperature above 150° C. for applications as described above.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

The invention relates to a lighting device, to the use of the lighting device in a photochemical reaction, to a photochemical reactor and to a method used by the lighting device. The lighting device comprises an LED unit configured to emit light to be used in the photochemical reaction, a housing configured to house the LED unit, wherein at least a part of the housing is transparent for light to be used in the photochemical reaction, wherein the housing is configured to contain a dielectric liquid transparent for light generated by the LED unit such that it is in direct contact with at least a part of the light emitting side of the LED unit, and a liquid movement arrangement configured to support a movement of the dielectric liquid such that the dielectric liquid transports heat produced by the LED unit away from the LED unit.

1-17. (canceled)

18. A lighting device for providing light (114) to be used in a photochemical reaction, wherein the lighting device (100, 100′) comprises:
an LED unit (110) configured to emit light (114) to be used in the photochemical reaction,
a housing (120, 120′) configured to house the LED unit (110), wherein at least a part of the housing (120, 120′) is transparent for light (114) to be used in the photochemical reaction, wherein the housing (120, 120′) is configured to contain a dielectric liquid transparent for light (114) generated by the LED unit (110) such that it is in direct contact with at least a part of a light emitting side of the LED unit, and
a liquid movement arrangement (130) configured to support a movement of the dielectric liquid such that the dielectric liquid transports heat produced by the LED unit (110) away from the LED unit (110).

19. The lighting device according to claim 18, wherein the liquid movement arrangement (130) comprises a liquid flow source (142) or is configured to be connected to a liquid flow source (142) configured to move the dielectric liquid.

20. The lighting device according to claim 18, wherein the liquid movement arrangement (130) comprises a cooling unit outside of the housing (120, 120′) or is adapted to be connected to a cooling unit configured for cooling the dielectric liquid.

21. The lighting device according to claim 18, wherein the lighting device (100, 100′) further comprises the dielectric liquid in the housing (120, 120′).

22. The lighting device according to claim 21, wherein the dielectric liquid comprises a refraction coefficient substantially similar to the refraction coefficient of the transparent part of the housing (120, 120′).

23. The lighting device according to claim 21, wherein the dielectric liquid is adapted to be movable by the liquid movement arrangement (130) in a temperature range from -35° C. to 150° C.

24. The lighting device according to claim 21, wherein the dielectric liquid is silicone oil or mineral oil.

25. The lighting device according to claim 18, wherein the LED unit (110) comprises an LED (111) and a mounting board (112), wherein the LED (111) is mounted to a first side of the mounting board (112), and wherein the mounting board (112) forms at least a part of the housing (120) such that the dielectric liquid is in direct contact with the LED (111) on the first side of the mounting board (112).

26. The lighting device according to claim 18, wherein the LED unit (110) comprises an LED (111) and a mounting board (112), wherein the LED (111) is mounted to a first side of the mounting board (112), and wherein the mounting board (112) is arranged in the housing (120′) such that the dielectric liquid is in direct contact with at least a part of the first side of the mounting board (112) and at least a part of a second side of the mounting board (112) opposite the first side.

27. The lighting device according to claim 25, wherein an additional cooling unit is provided on a second side of the mounting board (112) opposite the first side such that heat is transported away from the second side of the mounting board (112).

28. Use of a lighting device according to claim 18 as a light source in a photochemical reaction, wherein the light (114) emitted by the lighting device (100, 100′) is used to trigger and/or maintain a photochemical reaction in a medium provided in a photochemical reactor (300, 400).

29. A photochemical reactor, wherein the reactor (300, 400) comprises:
a reaction chamber configured to contain a reaction mixture as basis for the photochemical reaction, and
a lighting device (100, 100′) according to claim 18, wherein the light (114) emitted by the lighting device (100, 100′) triggers and/or maintains the photochemical reaction of the reaction mixture.

30. The reactor according to claim 29, wherein the reactor comprises a first conduit (310) and a second conduit (320), wherein the first conduit (310) is arranged inside the second conduit (320), wherein the reaction chamber is formed by the first conduit (310) and the lighting device (100, 100′) is arranged in the volume between the first conduit (310) and the second conduit (320) such that the light (114) provided by the lighting device (100, 100′) is radiated into the first conduit (310), or wherein the reaction chamber is formed by at least a part of the volume between the first conduit (310) and the second conduit (320) and the lighting device (100, 100′) is arranged inside the first conduit (310) such that the light (114) provided by the lighting device (100, 100′) is radiated into the volume between the first conduit (310) and the second conduit (320).

31. The reactor according to claim 30, wherein at least a part of the first conduit (310) forms at least a part of the housing (120, 120′) of the lighting device.

32. The reactor according to claim 31, wherein the reactor comprises the first conduit (310, 642) and the second conduit (320, 641), wherein the lighting device (100, 100′) is arranged in the volume between the first conduit (320, 641) and the second conduit (320, 641), wherein at least a part of the second conduit forms at least a part of the housing (120, 120′) of the lighting device, wherein the reactor comprises a liquid movement arrangement comprising a ring nozzle (600), wherein the ring nozzle (600) is arranged at at least one end of the first and second conduit (310, 320, 641, 642) such that the ring nozzle (600) closes the volume (643) between the first and second conduit (310, 320, 641, 642) at the end, wherein the ring nozzle (600) is adapted to guide the dielectric liquid from a connector arrangement (620), which is adapted to provide the dielectric liquid to the ring nozzle (600), to the volume between the first and second conduit (310, 320, 641, 642) comprising the lighting device (100, 100′).

33. The reactor according to claim 32, wherein the ring nozzle (600) comprises a circular volume (610) with a plurality of openings (611) that connect the volume (643) containing the lighting device (100, 100′) with the circular volume (610) of the ring nozzle (600), wherein the connector arrangement (620) is adapted to provide the dielectric liquid into the circular volume (610) and wherein the circular volume (610) comprises a shape that is narrower at a side of the conduits than at an opposite side.

34. A method for transporting heat away from an LED unit (110), wherein the method (500) comprises the steps of:
providing (510) a housing (120, 120′) that is configured to house the LED unit (110),
providing (520) a dielectric liquid in the housing (120, 120′) such that it is in direct contact with at least a part of a light emitting side of the of the LED unit (110), and
moving (530) the dielectric liquid in order to remove heat from the LED unit (110).
